(19) United States
(12) Patent Application Publication
(10) Pub. No.: US 2020/0260691 A1
(43) Pub. Date: Aug. 20, 2020

(54) Leash Base Apparatus

(71) Applicant: William A. Miller, Pompano Beach, FL (US)

(72) Inventor: William A. Miller, Pompano Beach, FL (US)

(21) Appl. No.: 16/786,320

(22) Filed: Feb. 10, 2020

Related U.S. Application Data
(60) Provisional application No. 62/805,484, filed on Feb. 14, 2019.

(51) Int. Cl. A01K 27/00; F16B 47/00

(52) U.S. Cl. CPC A01K 27/003; F16B 47/00

(57) ABSTRACT

The pet leash base includes a suction cup assembly with a rubber suction cup to engage a flat smooth anchoring surface with suction. A rigid base over the suction cup defines a handle with an internal volume leading to an opening on the bottom cup surface. An exit valve through the handle wall to the internal handle volume. An air pump to the internal handle volume pumps air out of the internal volume. A release actuator is coupled to a release valve allows airflow into the internal handle volume. A releasable leash connector on the handle receives a portion of a leash to hold the leash. The cover completely surrounds the entire suction cup assembly such that a lower periphery of the cover is configured to rest against the flat smooth anchor surface when the suction cup is engaged with the flat anchoring smooth surface. The cover has an opening to access the leash connector.

### CROSS-REFERENCE TO RELATED APPLICATION

This application claims priority to U.S. Provisional Patent Application No. 62/805,484 filed Feb. 14, 2019, the entirety of which is incorporated by reference.

### FIELD OF THE INVENTION

The present invention relates generally to pet accessories, and, more particularly, relates to a leash base that affixes to a flat smooth surface, provides a leash attachment point, and which protects the leash base from being chewed or otherwise compromised by the animal or other interference. The present invention relates to a leash base to securely attach a pet lease, such as a dog leash, to a flat surface, notwithstanding that the weight of the dog may exceed 55 pounds. These large dogs are capable of pulling typical prior art leash bases and thereby freeing the dog from the flat anchoring attachment surface (the leash base removably attached to the flat anchoring surface).

### BACKGROUND OF THE INVENTION

It is not uncommon for people to take their pets, dogs in particular, with them to places during outings or other activities. During these activities the dog is typically leashed, and the leash must be held by the owner or person responsible for the dog. This typically prevents the person from being able to use both hands as one hand is occupied holding the leash.

To allow the use of both hands it is not uncommon for people to tie the leash to an object, like a chair. Sometimes people use an auger anchor that “screw” into the ground, but this requires a suitable ground into which the anchor can be placed. Often people take their dogs with them in more developed areas where use of such an anchor would not be available. Tying the leash to chair my not prevent the dog from wandering, dragging the chair along by the leash. It's also possible that a leash tied to a relatively immovable object may come untied, particularly if the dog chews on the knot.

More precisely, large dogs (in excess of 55 pounds) can apply a significant pulling force on a leash. Also the dog tends to rotate quickly and hank and pull the leash mount repeatedly. Also the dog may attempt to bite the leash attachment, particularly at the leash mount surface adjacent the flat anchoring surface upon which the leash mount sits.

Therefore, a need exists to overcome the problems with the prior art as discussed above.

Prior art systems are inadequate. U.S. Pat. No. disclosure 5,022,351 to Daniels discloses a convertible leash tether system for securing a leash-retaining cartridge at a fixed location. The securing apparatus comprises a housing of a size and shape for securely holding the leash cartridge and the wound-up leash therein. A door locking mechanism locks the leash line when the leash-retaining cartridge is inside the housing. The tethered animal cannot dislodge the leach-retaining cartridge by excessive movement or force. One system to secure the housing and leach-retaining cartridge includes an auger for anchoring the apparatus in the ground. Other embodiments include clamps for clamping to above-ground objects, and suction cups for mounting the housing and leach-retaining cartridge to smooth anchoring surfaces so that the leash follows that which is tethered, thus resisting entanglement caused by movement of that which is tethered. The housing is oriented whereby the leash cartridge is held horizontally and is positioned relative to the anchor member whereby the opening for the leash cord is in close proximity to the point of attachment thereby.

U.S. Pat. No. disclosure 6,578,528 to Brown discloses a system for confining a pet within a preselected area by a pet anchoring apparatus that is relatively devoid of obstacles and potentially impaling protrusions, that can be varied in weight and size to accommodate the pet and the environment of the area in which the pet is to be confined, and that can be provided with an auxiliary cover. The restraining capacity of the anchoring base can use suction devices that can be positioned, for example, on the bottom surface of the base. The base cover can also be used to stabilize a plurality of anchoring bases in a stacked position wherein the cover fits over the several anchoring bases with sufficient snugness to help prevent any one of the bases from slipping out of position in the stack.

European patent disclosure EP 2266392 to Wang discloses a pet restraint device with a suction device, a hollow case, a driving element, and a connector. The suction device includes a suction disc and a tractor. The tractor is connected to the central top of the suction disc for moving the suction disc upward or downward to attach to or detach from a contact anchoring surface. The hollow case is located above the suction device and is provided centrally with a hole. The tractor of the suction device is inserted through the hole and extends above the hollow case. The driving element is located above the hollow case and is pivotally connected with the tractor of the suction device for moving the tractor upward and fixing the tractor after it is moved upward. The connector is provided on the case and is connected to a pet leash to retrain the pet.

U.S. Pat. No. 89,131,659 to Donaldson discloses a portable anchoring device providing a temporary anchoring means for pet leashes includes a round base containing a suction cup, a durable handle, and a clasp to which a dog leash can be attached. The suction cup provides removable attachment to a smooth horizontal or vertical surface via a second handle which pivots to actuate the suction cup and anchor the device.

The problem with all these prior art systems is that the cover does not extend substantially beyond the outer edge lip of the suction cup element. Hence, with the use of these prior art devices, the restrained pet can chew on, scratch, or otherwise destroy or deteriorate the edge of the suction element, thereby causing the suction element to release its attachment to the flat, anchor mounting surface.

### SUMMARY OF THE INVENTION

In one embodiment, the pet leash base includes a suction cup assembly having certain features. The suction assembly has a rubber suction cup having a bottom surface configured to engage a flat smooth anchoring surface with suction. A rigid base is disposed over a top of the suction cup. A handle on the rigid base has an internal volume with an opening to the bottom surface of the suction cup. An exit valve is provided through a wall of the handle from the internal volume to an outside of the handle. An air pump is disposed in the internal volume of the handle that is configured to pump air out of the internal volume of the handle upon manual actuation of a pump actuator connected to the air pump and disposed on the outside of the handle. A release actuator is disposed on the outside of the handle and is coupled to a release valve that is configured to, upon actuation of the release actuator, to allow air from outside the handle into the internal volume of the handle. A releasable leash connector is disposed on the handle and is configured to receive a portion of a leash to hold the leash. A cover is configured to attach to, and completely surround the entire suction cup assembly such that a lower periphery of the cover is configured to rest against the flat smooth anchor surface when the suction cup is engaged with the flat anchoring smooth surface. The cover has an opening configured to allow access to the releasable leash connector, release actuator, and pump actuator by a person.

Other embodiments of the present invention include a cover configured such that the release actuator is sufficiently below an exterior surface of the cover such that an animal cannot bite the release actuator. The cover may be a domed cover. The cover may have engagement features on the inside of the cover, proximate the lower periphery of the cover, that correspond with and engage retaining features on a side of the rigid base. These engagement features and the retaining features may include a detent.

The invention provides an innovative leash mount that overcomes the earlier described disadvantages in the prior art.

With the foregoing and other objects in view, there is provided, in accordance with the invention, a cover that completely surrounds the entire suction cup assembly such that a lower periphery of the cover is configured to rest against the flat smooth anchor surface when the suction cup is engaged with the flat anchoring smooth surface. The cover has an opening to access the leash connector. The suction cup assembly is attached to a handle with an internal volume leading to the bottom of the suction cup.

In accordance with another feature, an embodiment of the present invention includes an air pump to pump out air from an internal volume of a handle.

In accordance with a further feature of the present invention, the present invention includes a release value to permit air to enter into the internal volume of a handle.

Although the invention is illustrated and described herein as embodied in a leash base apparatus, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

In the description of the embodiments of the present invention, unless otherwise specified, azimuth or positional relationships indicated by terms such as “up”, “down”, “left”, “right”, “inside”, “outside”, “front”, “back”, “head”, “tail” and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first”, “second”, “third” and so on are only used for descriptive purposes, and cannot be construed as indicating or implying relative importance.

In the description of the embodiments of the present invention, it should be noted that, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. Those skilled in the art can understand the specific meanings of the above-mentioned terms in the embodiments of the present invention according to the specific circumstances.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is an exploded side view of a leash base, in accordance with some embodiments;

FIG. 2 is a perspective view of a leash base, in accordance with some embodiments;

FIG. 3 is a detail of a retaining feature on a side of a base of a leash base, in accordance with some embodiments; and

FIG. 4 is an assembly diagram of a leash base, in accordance with some embodiments.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

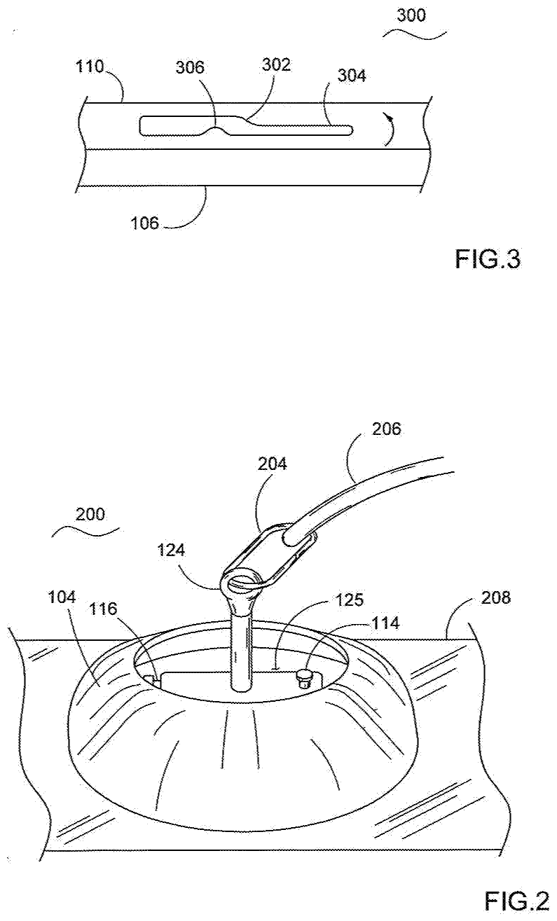

The present invention provides a novel and efficient leash base that employs suction or a vacuum to affix the leash base to a smooth flat surface, while also preventing the leashed animal (or any other animal) from chewing on, or scratching at the leash base in a way that would release the lease base from the smooth flat surface. More precisely, the outer cover 104 is dimensionally larger than the suction cup member 106 (the suction cup 106 removably but securely attached to the flat anchor surface 208 (see FIG. 2)) such that the aggressive dog cannot chew on or otherwise destroy, alter, scratch or otherwise adversely effect the suction cup 106 attachment to the flat anchor surface 208.

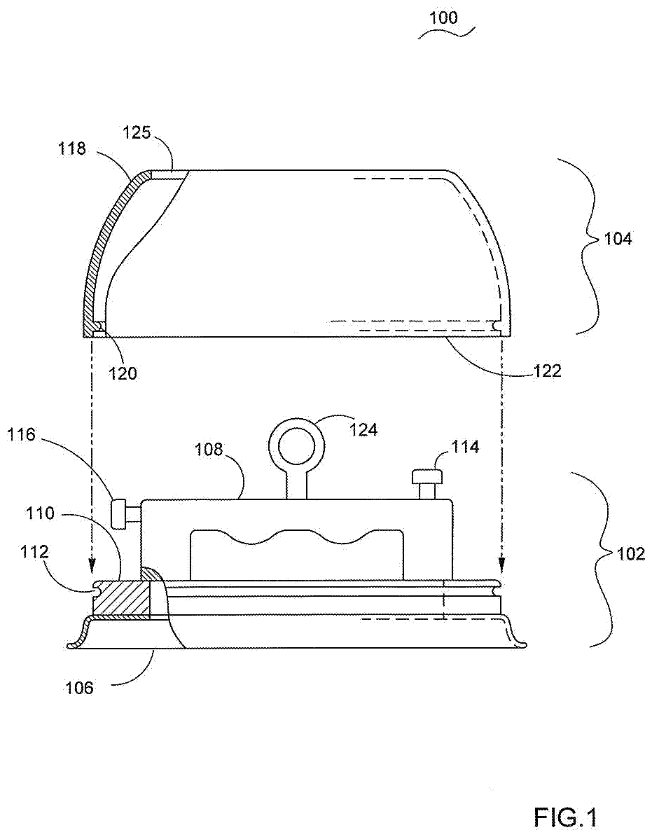

FIG. 1 is an exploded side view of a leash base 100, in accordance with some embodiments. The leash base includes a suction cup assembly 102 and a cover 104. The suction cup assembly 102 includes a suction cup member 106, or more simply, suction cup, that is configured to affix to a flat smooth surface via suction/vacuum and is made of a gas impermeable material like, for example, rubber. To support the suction cup 106 is a rigid base 110 that further supports a hollow handle 108. The hollow handle has an internal space that is generally sealed, and houses a pump mechanism which can be operated by pump actuator 114 to pump air out of the internal volume of the handle through an exit valve in the handle. The exit valve can operate, in one configuration, as a one way valve while pumping air out of the handle. The internal as air is pumped out of the internal volume of the handle, a vacuum results. The internal volume is also in operative communication with the suction sup 106 to act on the suction cup 106. Either the vacuum created in the handle 108 can draw the center of the suction cup 106 up towards the handle 108, thereby indirectly creating a similar vacuum between the suction cup 106 and a flat smooth surface, or there can be an air channel through the suction cup 106 into the internal volume so that the vacuum is created directly between the bottom surface of the suction cup 106 and the flat smooth surface.

Thus, the leash base 100 can be placed on a flat, smooth anchor surface 208 (FIG. 2, surface 208), meaning the bottom of the suction cup 106 is on the flat smooth anchor surface, and the pump actuator 114 can be operated to create a vacuum between the suction cup 106 and the surface.

A leash attachment member 124 is coupled to or formed with the handle 108, and is configured so that a leash can be attached to it. The cover 104 is placed over the suction sup assembly 102, and has a lower periphery (edge) 122 that encircles the suction cup 106 and extends beyond the periphery of the suction cup 106 and can rest against the surface, so that there is no, or very little gap between the lower periphery 122 and the surface, and the suction cup 106 is not exposed, thereby preventing the dog or other animal from being able to chew on, or scratch the suction cup 106.

The cover 104 can have a domed body 118 that can be circular or elliptical, but lack corners, edges, or other features that a dog could bite or scratch against. At the top of the cover 104 is a narrow opening 125 through which the leash attachment member 124 extends, and through which a user can actuate the pump actuator 114. The cover 104 can attach to the suction cup assembly 102 by an engagement feature 120 formed in the inside of the cover 104 near the lower periphery 122 which corresponds to a mating retaining feature 112 formed on the base 110.

The retaining and engagement features 120, 112, can be an interference engagement including a detent aspect that requires to user to exert some moderate force to overcome, and then the force reduces, thereby retaining the cover 104 on the base 110. When the user is done and wishes to leave, a release actuator 116 can be operated by the user through opening 125 to allow air back into the handle, thereby eliminating the vacuum and releasing the suction cup 106 from the surface.

The release actuator can open a release valve, or open the normally one way valve that operates in conjunction with the pump mechanism to pump air out of the handle.

Although the suction cup assembly 102 is shown here as including a pump, it is contemplated that other mechanisms can be used to create the vacuum, including, for example, a cam lever that pulls the center of the suction cup 106 away from the surface to create a vacuum between the suction cup 106 and the surface. Likewise, such a lever can then release the vacuum by reversing the movement of the lever. The use of such a lever is well known in suction devices used for moving panes of glass and other similarly smooth objects.

FIG. 2 is a perspective view 200 of a leash base, in accordance with some embodiments. The leash base here can be substantially similar to that of FIG. 1, and so common reference numerals are used here. The suction cup assembly (e.g. 102) is hidden from view under the cover 104, but it can be assumed that the suction cup is affixed to surface 208 by a vacuum between the suction cup and the surface 208. Cup member 106 (FIG. 1) is removably secured to flat, smooth anchor surface 208. The leash attachment member 124 can be seen protruding through opening 125, through which the pump actuator 114 and release actuator 116 can be seen as well. The actuators 114, 116 can be reached and operated by a person, but the cover 104 is formed so that the opening 125 is narrow enough, and the actuators 114, 116 are deep enough below the top 202 of the cover 104 so at to prevent a dog or other animal from being able to operate the release actuator 116. A leash 206 can be attached to the leash attachment member 124 with a clip 204 or similar feature that can be disposed on the leash attachment member 124 or the leash 206.

FIG. 3 is a detail 300 of a retaining feature 302 on a side of a leash base 110, in accordance with some embodiments. Continuing to use the reference numerals of FIG. 1, and rigid base 110 supports a suction cup 106. On the side of the base 110 there can be a plurality of retaining features like retaining feature 302 that are configured to engage corresponding engagement features formed on the inside of the cover. Variations and alterative structures will occur to those skilled in the art that can be used to equivalently achieve the same result.

The retainer feature 302 protrudes from the side of the base, and include a ramped portion 304 and a capture portion 306. A similar round protrusion on the inside of the cover can be configured such that, when the cover is placed over the suction cup assembly, the protrusion on the inside of the cover meets the ramped portion 304 at bottom of the ramped portion 304. As the cover is turned, once the suction cup 106 is affixed to the surface, the protrusion on the inside of the cover is deflected downward, and the ramped portion 304 and base 110 can be lifted, but a substantial force will exist between the ramped portion and the protrusion on the inside of the cover.

The cover can be turned, increasing the force between the ramp portion 304 and the cover protrusion, until the protrusion on the inside of the cover is in the capture portion 306, which reduces the force between them, and retains the cover in position. During this process the bottom of the cover will be bearing against the surface. When the user wishes to remove the cover the suction cup can be released, or the cover can be rotated in the opposite direction to disengage the engagement feature of the cover from the retaining features 302.

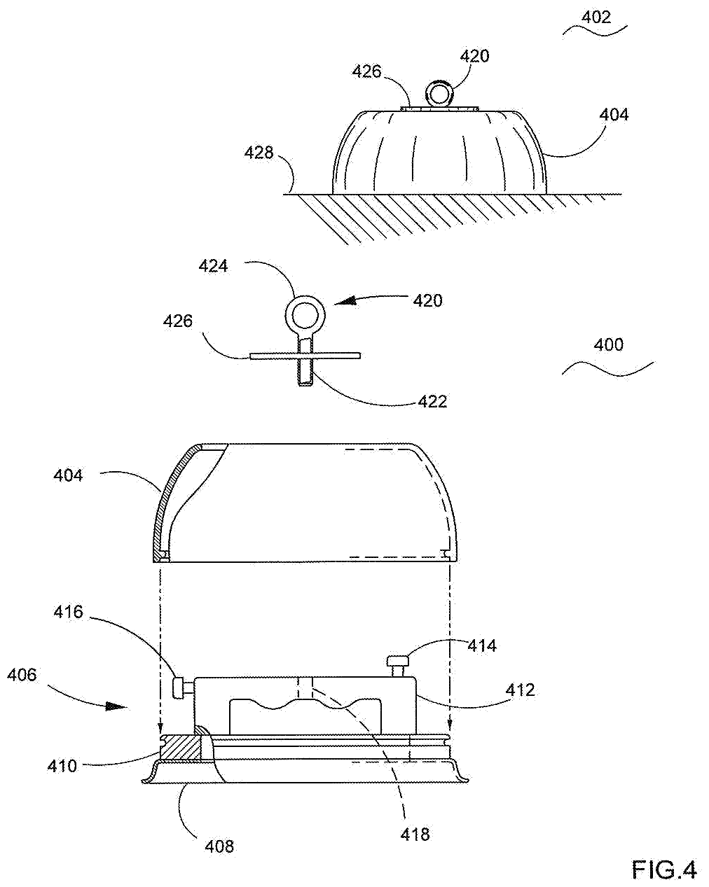

FIG. 4 is an assembly diagram of a leash base, in accordance with some embodiments. In view 400 the leash base is unassembled, and in view 402 the leash base is assembled. The leash base includes a cover 404 and a suction cup assembly 406 which includes a suction cup 408 and a rigid base 410. A handle 412 is attached to, or integral with, the base 110. A pump actuator 414 is provided on the handle 412 to operate an air pump inside the handle 412. A release actuator 416 is provided to release the vacuum created by the air pump by allowing air into the handle. Unlike in FIG. 1, where opening 125 allowed access to the actuators 114, 116, in the embodiments represented by FIG. 4, the cover 404 does not allow access to the actuators 414, 416 when installed.

To install the cover 404 over the suction cup assembly 406, the suction cup assembly 406 can first be affixed to an anchor surface 428. The cover 404 can then be placed over the suction cup assembly 406. A leash attachment member 420 can have a threaded shank 422 that passes through a hole in the top of the cover 404 to engage a threaded hole 418 in the handle 412 of the suction cup assembly 406. A washer 426 can also be provided over the threaded shank 422 to bear against the outside surface of the cover 404 to urge the cover 404 against the surface 428 when the leash attachment member 420 is screwed into the threaded hole 418 sufficiently to cause the bottom of a leash loop portion 424 (or eye portion) to bear against the washer 426. A leash can be attached to the leash loop portion 424, securing the dog to the object to which the leash base is affixed.

The claims appended hereto are meant to cover modifications and changes within the scope of the invention.

What is claimed is:

1. A pet leash base, comprising:
a suction cup assembly having:
a rubber suction cup having a bottom surface configured to engage a flat smooth anchoring surface with suction;
a rigid base disposed over a top of the suction cup;
a handle on the rigid base that has an internal volume having opening to bottom surface of the suction cup;
an exit valve provided through a wall of the handle from the internal volume to an outside of the handle;
an air pump disposed in the internal volume of the handle that is configured to pump air out of the internal volume of the handle upon manual actuation of a pump actuator connected to the air pump and disposed on the outside of the handle;
a release actuator disposed on the outside of the handle and coupled to a release valve that is configured to, upon actuation of the release actuator, allow air from outside the handle into the internal volume of the handle;
a releasable leash connector disposed on the handle and configured to receive a portion of a leash to hold the leash; and
a cover configured to attach to, and completely surround the entire suction cup assembly such that a lower periphery of the cover is configured to rest against the flat smooth anchor surface when the suction cup is engaged with the flat smooth surface, and has an opening configured to allow access to the releasable leash connector, release actuator, and pump actuator by a person.

2. The pet leash base of claim 1, wherein the cover is further configured so that the release actuator is sufficiently below an exterior surface of the cover such that an animal cannot bite the release actuator.

3. The pet leash base of claim 1, wherein the cover is a domed cover.

4. The pet leash base of claim 1, wherein the cover has engagement features on an inside of the cover proximate the lower periphery that correspond with and engage retaining features on a side of the rigid base.

5. The pet leash base of claim 4, wherein the engagement features and the retaining features comprise a detent.

6. An apparatus, comprising:
a suction device having a suction cup made a compliant gas impermeable material, a suction activation mechanism configured to, upon activation by a user, create a vacuum between the suction cup and a smooth flat surface, a release mechanism configured to, upon activation by a user, eliminate the vacuum, the suction device including a rigid member for supporting the suction cup, suction activation mechanism and release mechanism;
a cover configured to fit over the suction device, around the suction device on the smooth flat surface, and over the suction device; and
a leash attachment member that is configured to attach to the rigid member through the cover, exposing an attachment portion of the leash attachment member.

7. The apparatus of claim 6, wherein the cover is a domed cover.

8. The apparatus of claim 6, wherein the leash attachment member has a threaded shank that engages a threaded hole on the rigid member and captures the cover over the suction device.

9. The apparatus of claim 6, wherein the suction activation mechanism comprises a pumps air out of the suction device to create the vacuum.

10. The apparatus of claim 9, wherein the release mechanism comprises a release valve with a release actuator.

11. The apparatus of claim 6, wherein the suction activation mechanism and the release mechanism are both implement as a lever that moves a center portion of the suction cup to create or release the vacuum.
